(19) United States
(12) Patent Application Publication
(10) Pub. No.: US 2017/0341194 A1
(43) Pub. Date: Nov. 30, 2017

(54) DOOR ASSEMBLY FOR MICROWAVE OVEN, AND METHOD AND DEVICE FOR CONTROLLING SAME

(71) Applicants: Beijing Xiaomi Mobile Software Co., Ltd., Beijing (CN); Beijing Smartmi Technology Co., Ltd., Beijing (CN)

(72) Inventors: Tie LIU, Beijing (CN); Jicheng LUO, Beijing (CN); Mengnan WANG, Beijing (CN)

(73) Assignees: Beijing Xiaomi Mobile Software Co., Ltd.; Beijing Smartmi Technology Co., Ltd.

(21) Appl. No.: 15/607,219

(22) Filed: May 26, 2017

(30) Foreign Application Priority Data
May 30, 2016 (CN) 201610371796.0

(51) Int. Cl. B23Q 3/154; H01F 7/06; H01F 7/02; H01H 5/02

(52) U.S. Cl. CPC B23Q 3/1543; H01F 7/064; H01F 7/06; H01F 7/0205; H01H 5/02

(57) ABSTRACT

A door assembly includes: a door including a first region; a doorframe connected to the door through a door hinge, the doorframe including a second region, wherein the first region faces the second region when the door is closed; an electromagnet located at one of the first and second regions; a permanent magnet located at the other one of the first and second regions; a distance sensor configured to detect a distance between the door and the doorframe; and a control chip coupled with the distance sensor, the control chip being configured to control a direction of a current in the electromagnet according to the distance detected by the distance sensor.

### CROSS-REFERENCE TO RELATED APPLICATIONS

This application is based upon and claims priority to Chinese Patent Application No. 201610371796.0, filed May 30, 2016, the entire contents of which are incorporated herein by reference.

### TECHNICAL FIELD

The present disclosure generally relates to smart home technology and, more particularly, to a door assembly for a microwave oven, and a method and a device for controlling the door assembly.

### BACKGROUND

Typically, a user can open or close a door of a microwave oven by manually pulling or pushing the door. However, when the pulling or pushing force applied by the user is insufficient to move the door, the user cannot open or close the door normally.

### SUMMARY

According to a first aspect of the present disclosure, there is provided a door assembly, comprising: a door including a first region; a doorframe connected to the door through a door hinge, the doorframe including a second region, wherein the first region faces the second region when the door is closed; an electromagnet located at one of the first and second regions; a permanent magnet located at the other one of the first and second regions; a distance sensor configured to detect a distance between the door and the doorframe; and a control chip coupled with the distance sensor, the control chip being configured to control a direction of a current in the electromagnet according to the distance detected by the distance sensor.

According to a second aspect of the present disclosure, there is provided a method for controlling a door assembly, wherein the door assembly includes a door, a doorframe connected to the door through a door hinge, an electromagnet located at one of the door and the doorframe, a permanent magnet located at the other one of the door and the doorframe, a distance sensor configured to detect a distance between the door and the doorframe, and a control chip coupled with the distance sensor, the method comprising: supplying, by the control chip, a current in a first direction to the electromagnet when the control chip receives a first control signal transmitted from the distance sensor, so that the electromagnet attracts the permanent magnet, the first control signal being generated by the distance sensor when the distance sensor detects the distance between the door and the doorframe is decreasing; supplying, by the control chip, a current in a second direction to the electromagnet when the control chip receives a second control signal transmitted from the distance sensor, so that the electromagnet repels the permanent magnet, the second control signal being generated by the distance sensor when the distance sensor detects the distance between the door and the doorframe is increasing, wherein the first direction differs from the second direction.

According to a third aspect of the present disclosure, there is provided a device for controlling a door assembly, wherein the door assembly includes a door, a doorframe connected to the door through a door hinge, an electromagnet located at one of the door and the doorframe, a permanent magnet located at the other one of the door and the doorframe, and a distance sensor configured to detect a distance between the door and the doorframe, the device comprising: a processor; and a memory configured to store instructions executable by the processor; wherein the processor is configured to: when receiving a first control signal transmitted from the distance sensor, supply the electromagnet with a current in a first direction, so that the electromagnet attracts the permanent magnet, the first control signal being generated by the distance sensor when the distance sensor detects the distance between the door and the doorframe is decreasing; and when receiving a second control signal transmitted from the distance sensor, supply the electromagnet with a current in a second direction, so that the electromagnet repels the permanent magnet, the second control signal being generated by the distance sensor when the distance sensor detects the distance between the door and the doorframe is increasing, wherein the first direction differs from the second direction.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1A is a schematic diagram illustrating a door assembly used in a microwave oven, according to an exemplary embodiment.

FIG. 1B is a block diagram showing further aspects of the door assembly shown in FIG. 1A, according to an exemplary embodiment.

FIG. 1C is a schematic diagram illustrating a top view of the door assembly shown in FIG. 1A, according to an exemplary embodiment.

FIG. 1D is a schematic diagram illustrating a top view of the door assembly shown in FIG. 1A, according to another exemplary embodiment.

FIG. 2 is a flowchart of a method for controlling a door assembly, according to an exemplary embodiment.

FIG. 3 is a flowchart of a method for controlling a door assembly, according to an exemplary embodiment.

FIG. 4A is a block diagram of a device for controlling a door assembly, according to an exemplary embodiment.

FIG. 4B is a block diagram of a device for controlling a door assembly, according to another exemplary embodiment.

FIG. 5 is a block diagram of a device for controlling a door assembly, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

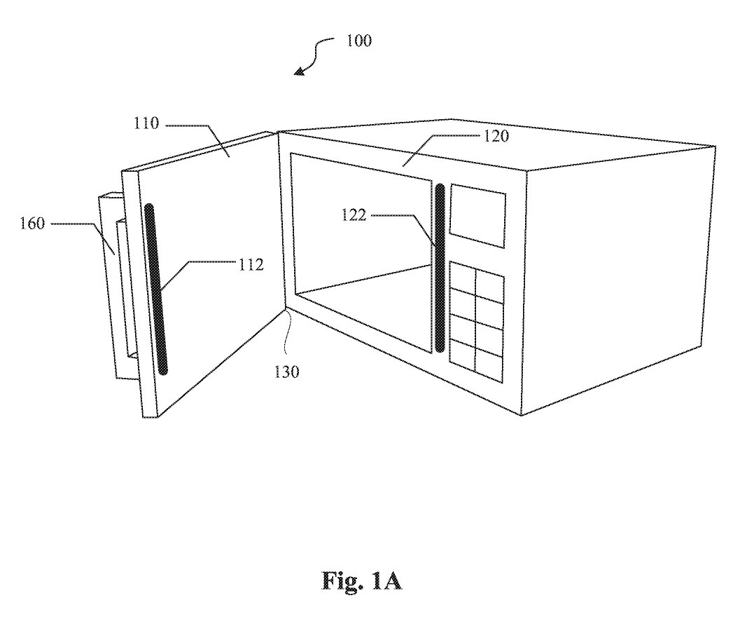

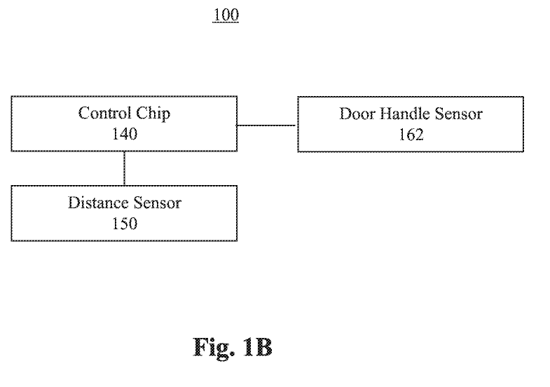

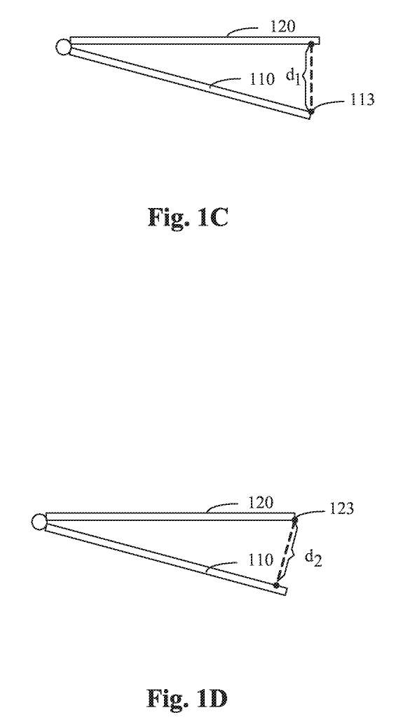

FIG. 1A is a schematic diagram of a door assembly 100 used in a microwave oven 10, according to an exemplary embodiment. Referring to FIG. 1A, the door assembly 100 includes at least a door 110, a doorframe 120, and a door hinge 130.

As illustrated in FIG. 1A, the door 110 is connected to the doorframe 120 through the door hinge 130. When the door 110 is closed, at least part of the door 110 directly faces and/or contacts the doorframe 120. For example, a region 112 of the door 110 faces or contacts a region 122 of the doorframe 120 when the door 110 is closed. The door 110 includes a first magnet located at the region 112, and the doorframe 120 includes a second magnet located at the region 122. One of the first and second magnets is a permanent magnet, and the other one of the first and second magnets is an electromagnet.

The permanent magnet constantly generates a magnetic field, without requiring external power input. In contrast, for the electromagnet to produce and maintain a magnetic field, an electric current is required to be input into a coil surrounding the electromagnet. The magnetic field generated by the electromagnet can be controlled by adjusting the amplitude and/or direction of the current passing through the coil. Specifically, the strength of the magnetic field generated by the electromagnet is proportional to the amount of the current, and the direction of the magnetic field is controlled by the direction of the current.

FIG. 1B is a block diagram showing further aspects of the door assembly 100 shown in FIG. 1A, according to an exemplary embodiment. Referring to FIG. 1B, the door assembly 100 further includes a control chip 140 and a distance sensor 150, in addition to the door 110, the doorframe 120, and the door hinge 130 shown in FIG. 1A. The control chip 140 is communicatively connected to the distance sensor 150. The distance sensor 150 is configured to detect a distance and/or a change of the distance between the door 110 and the doorframe 120, and the control chip 140 is configured to control the direction and/or the amount of an electric current (i.e., current direction) in a coil of the electromagnet according to the distance and/or the change of the distance detected by the distance sensor 150.

The distance sensor 150 may be embedded in or mounted at any suitable position on the microwave oven 10. Referring to FIG. 1A, the distance sensor 150 may be located at the first region 112, the second region 122, or other positions, which are not limited by the present embodiment.

In the disclosed embodiments, depending on the position of the distance sensor 150, the distance detected by the distance sensor 150 is defined differently.

FIG. 1C is a schematic diagram illustrating a top view of the door assembly 100, according to an exemplary embodiment. Referring to FIG. 1C, the distance sensor 150 is located at a first mounting position 113 in the first region 112 of the door 110, and the distance detected by the distance sensor 150 is a distance from the first mounting position 113 to a plane on which the doorframe 120 is located. This distance is shown as d₁ in FIG. 1C.

FIG. 1D is a schematic diagram illustrating a top view of the door assembly 100, according to another exemplary embodiment. Referring to FIG. 1D, the distance sensor 150 is located at a second mounting position 123 in the second region 122 of the doorframe 120, and the distance detected by the distance sensor 150 is a distance from the second mounting position 123 to a plane on which the door 110 is located. This distance is shown as d₂ in FIG. 1D.

In the disclosed embodiments, the control chip 140 may be embedded in the distance sensor 150, or may be located at another position separate from the distance sensor 150. The present disclosure does not limit the position of the control chip 140.

Referring back to FIG. 1A, in the disclosed embodiments, a door handle 160 is mounted on the door 110. Referring to FIG. 1B, in some embodiments, the door assembly 100 further includes a door handle sensor 162 built in the door handle 160. The door handle sensor 162 is configured to detect one or more parameters indicative of certain surface characteristics of the door handle 160, such as the surface temperature, the surface brightness, and/or the surface pressure of the door handle 160. The door handle sensor 162 may be coupled with the control chip 140 or distance sensor 150 via a wired connection.

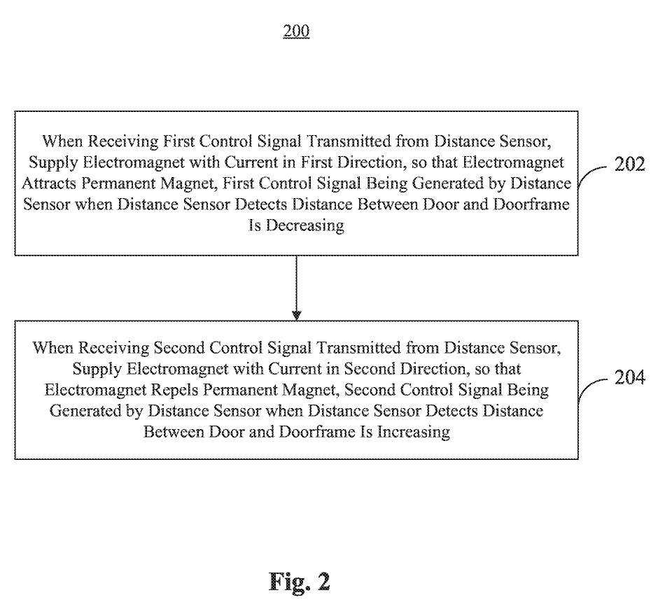

FIG. 2 is a flowchart of a method 200 for controlling a door assembly, according to an exemplary embodiment. For example, the method 200 can be performed to control the door assembly 100 illustrated in FIGS. 1A and 1B. As discussed above, an electromagnet is arbitrarily located at one of the region 112 and the region 122, and a permanent magnet is located at the other one of the region 112 and the region 122. Referring to FIG. 2, the method 200 includes the following steps 202 and 204.

In step 202, when receiving a first control signal transmitted from the distance sensor 150, the control chip 140 supplies the electromagnet with a current in a first direction, so that the electromagnet attracts the permanent magnet. The first control signal is generated by the distance sensor 150 when the distance sensor 150 detects the distance between the door 110 and the doorframe 120 is decreasing.

In step 204, when receiving a second control signal transmitted from the distance sensor 150, the control chip 140 supplies the electromagnet with a current in a second direction, so that the electromagnet repels the permanent magnet. The second control signal is generated by the distance sensor 150 when the distance sensor 150 detects the distance between the door 110 and the doorframe 120 is increasing.

According to the method 200, the control chip 140 supplies the electromagnet with a current in a direction corresponding to the control signal received from the distance sensor 150, so as to control the electromagnet to attract or repel the permanent magnet. The control signal is generated by the distance sensor 150 according to the detected change of the distance between the door 110 and the doorframe 120. This way, when a user pushes or pulls the door 110, the door assembly 100 automatically generates a force in the same direction as the user-intended moving direction of the door 110, thereby reducing the force required by the user to push or pull the door 110. As such, the method 200 solves the problem that the door 110 cannot be opened or closed normally when the force exerted by the user is not enough to move the door 110.

In practice, sometimes the distance between the door 110 and the doorframe 120 is changed not by the user, but is changed instead due to environmental factors such as wind force. As such, in some embodiments, to prevent the distance sensor 150 from detecting and reporting those distance changes not intended by the user, the door handle sensor 162 is used to detect whether a distance change is actually caused by the user. Specifically, when the door handle sensor 162 detects that a parameter indicative of a surface characteristic of the door handle 160 reaches a certain predetermined parameter level, the door sensor transmits an activation signal to the control chip 140. When receiving the activation signal from the door handle sensor 162, the control chip 140 transmits an activation instruction to the distance sensor 150 for triggering the distance sensor 150 to detect a distance change between the door 110 and the doorframe 120. This way, because the activation signal is generated when the parameter detected by the door handle sensor 162 reaches the predetermined parameter level, the door assembly 100 can be made to only respond to distance changes that are actually caused by the user. Therefore, the power consumption of the door assembly 100 is reduced.

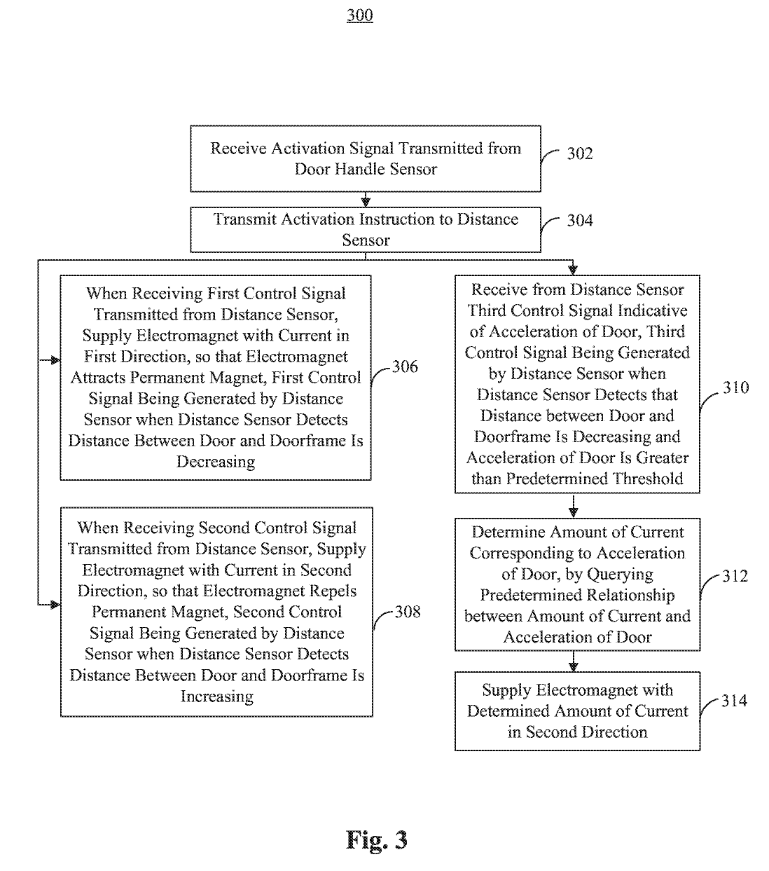

FIG. 3 is a flowchart of a method 300 for controlling a door assembly, according to an exemplary embodiment. For example, the method 300 can be performed to control the door assembly 100. Referring to FIG. 3, the method 300 includes the following steps 302-314.

In step 302, the control chip 140 receives an activation signal transmitted from the door handle sensor 162.

Here, the activation signal is generated by the door handle sensor 162 when a parameter detected by the door handle sensor 162 reaches a predetermined parameter level. Specifically, the door handle sensor 162 determines whether the detected parameter reaches the predetermined parameter level. When the parameter is determined to reach the predetermined parameter level, the door handle sensor 162 transmits the activation signal to the control chip 140.

For example, the values of the parameter detected by the door handle sensor 162 may have at least two levels. The first parameter level is from 1 to 10, and the second parameter level is from 11 to 20. The predetermined parameter level that triggers the generating and transmitting of the activation signal is the second parameter level. For example, when the parameter detected by the door handle sensor 162 is 9, the door handle sensor 162 determines that the parameter of 9 does not reach the second parameter level, and thus performs no further operations. In contrast, when the parameter detected by the door handle sensor 162 is 13, the door handle sensor 162 determines that the parameter of 13 reaches the second parameter level and thus transmits the activation signal to the control chip 140. The above example is for illustrative purpose only. The present disclosure does not limit the specific manner for defining the predetermined parameter level.

The parameter detected by the door handle sensor 162 is indicative of one or more surface characteristics of the door handle 160. For example, the one or more surface characteristics may include but are not limited to: the surface temperature of the door handle 160, the brightness at the surface of the door handle 160, and/or the pressure applied on the surface of the door handle 160.

In step 304, the control chip 140 transmits an activation instruction to the distance sensor 150.

Here, the activation instruction is configured to trigger the distance sensor 150 to detect a change of the distance between the door 110 and the doorframe 120.

In step 306, when receiving a first control signal transmitted from the distance sensor 150, the control chip 140 supplies the electromagnet with an electric current in a first direction, so that the electromagnet attracts the permanent magnet.

Here, the first control signal is generated by the distance sensor 150 when the distance sensor 150 detects a distance between the door 110 and the doorframe 120 is decreasing. The current in the first direction causes a pole of the electromagnet to align towards an opposite pole of the permanent magnet, so that the electromagnet attracts the permanent magnet. Because, as described above, the electromagnet is arbitrarily located at one of the first region 112 of the door 110 and the second region 122 of the doorframe 120 and the permanent magnet is located at the other one of the first region 112 and the second region 122, the opposite poles create an attraction force between the door 110 and the doorframe 120.

Consistent with the disclosed embodiments, the decreasing of the distance between the door 110 and the doorframe 120 indicates that an external force (e.g., a force applied by a user of the microwave oven 10) is pushing the door 110 and causes the door 110 to approach the doorframe 120. With the simultaneous generation of the attraction force between the door 110 and the doorframe 120, the amount of external force needed for closing the door 110 is effectively reduced.

In step 308, when receiving a second control signal transmitted from the distance sensor 150, the control chip 140 supplies the electromagnet with an electric current in a second direction, so that the electromagnet repels the permanent magnet. The second direction is different from the first direction.

Here, the second control signal is generated when the distance sensor 150 detects the distance between the door 110 and the doorframe 120 is increasing. The current in the second direction causes a pole of the electromagnet to align towards a like pole of the permanent magnet, so that the electromagnet repels the permanent magnet. Because the electromagnet is arbitrarily located at one of the first region 112 of the door 110 and the second region 122 of the doorframe 120 and the permanent magnet is located at the other one of the first region 112 and the second region 122, the like poles create a repulsion force between the door 110 and the doorframe 120.

Consistent with the disclosed embodiments, the increasing of the distance between the door 110 and the doorframe 120 indicates that an external force (e.g., a force applied by the user of the microwave oven 10) is pulling the door 110 and causes the door 110 to move away from the doorframe 120. With the generation of the repulsion force between the door 110 and the doorframe 120, the amount of external force needed for opening the door 110 is effectively reduced.

In step 310, the control chip 140 receives from the distance sensor 150 a third control signal indicative of an acceleration of the door 110. Here, the third control signal is generated by the distance sensor 150 when the distance sensor 150 detects that the distance between the door 110 and the doorframe 120 is decreasing and the acceleration of the door 110 is greater than a predetermined threshold of the acceleration. The present disclosure does not limit the value of the threshold.

In step 312, the control chip 140 determines an amount of current corresponding to the acceleration of the door 110, by querying a predetermined relationship between the amount of the current and the acceleration of the door 110.

Here, the determined amount of current is positively correlated to the acceleration of the door 110. That is, the larger the acceleration of the door 110 is, the larger the determined amount of current is.

In step 314, the control chip 140 supplies the electromagnet with the determined amount of current in the second direction.

As known in the relevant art, the electromagnetic force caused by magnetic induction can be determined according to the following equation: F=B×I×L, where F is the electromagnetic force generated by a conductor, B is the intensity of a magnetic field surrounding the conductor, I is the amount of an electric current flowing through the conductor, and L is the length of the conductor. Accordingly, the electromagnetic force generated by the electromagnet is positively correlated to the amount of current flowing through the coil of the electromagnet. That is, by increasing the amount of the current flowing in the second direction, a larger repulsion force can be generated between the door 110 and the doorframe 120.

According to the method 300, the control chip 140 supplies the electromagnet with a current in a direction corresponding to the control signal received from the distance sensor 150, so as to control the electromagnet to attract or repel the permanent magnet. The control signal is generated by the distance sensor 150 according to the detected change of the distance between the door 110 and the doorframe 120. This way, when a user pushes or pulls the door 110, the door assembly 100 automatically generates a force in the same direction as the user-intended moving direction of the door 110, thereby reducing the force required from the user to push or pull the door. As such, the method 300 solves the problem that the door 110 cannot be opened or closed normally when the force exerted by the user is not enough to move the door 110.

Moreover, according to the method 300, the control chip 140 supplies the electromagnet with a determined amount of current in the second direction when the distance between the door 110 and the doorframe 120 is decreasing and the acceleration of the door 110 is greater than a predetermined acceleration threshold. The determined amount of current is positively correlated to the acceleration of the door 110. As such, when the door 110 is closed too fast, a repulsion force corresponding to the acceleration is produced between the door 110 and the doorframe 120 to prevent the door 110 and/or doorframe 120 from being damaged by large impacts.

Next, the device embodiments of the present disclosure will be described. The disclosed device embodiments are configured to perform the above-described methods. Details that are not described in connection with the device embodiments below can be understood by referring to the relevant description in the above method embodiments.

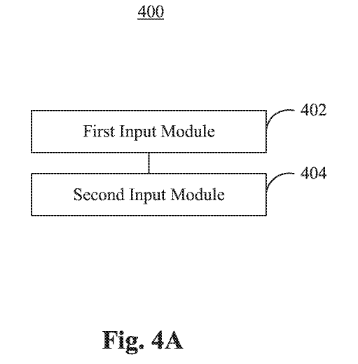

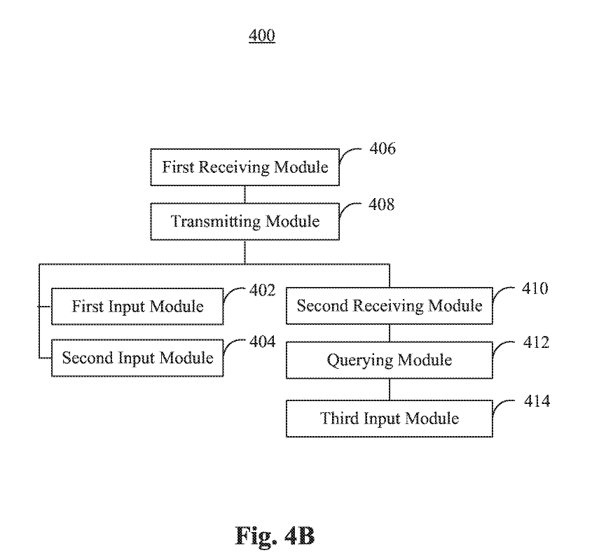

FIG. 4A is a block diagram of a device 400 for controlling a door assembly, according to an exemplary embodiment. For example, the device 400 may be used for controlling the door assembly 100 illustrated in FIGS. 1A and 1B, and implemented as a part or the whole of control chip 140. Referring to FIG. 4A, the device 400 includes at least a first input module 402 and a second input module 404.

The first input module 402 is configured to supply a current in a first direction to the electromagnet when the device 400 receives a first control signal transmitted from the distance sensor 150, so that the electromagnet attracts the permanent magnet. The first control signal is generated by the distance sensor 150 when the distance sensor 150 detects a distance between the door 110 and the doorframe 120 is decreasing.

The current in the first direction causes a pole of the electromagnet to align towards an opposite pole of the permanent magnet, so that the electromagnet attracts the permanent magnet. Because, as described above, the electromagnet is arbitrarily located at one of the first region 112 of the door 110 and the second region 122 of the doorframe 120 and the permanent magnet is located at the other one of the first region 112 and the second region 122, the unlike poles create an attraction force between the door 110 and the doorframe 120.

Consistent with the disclosed embodiments, the decreasing of the distance between the door 110 and the doorframe 120 indicates that an external force (e.g., a force applied by a user of the microwave oven 10) is pushing the door 110 and causes the door 110 to approach the doorframe 120. With the generation of the attraction force between the door 110 and the doorframe 120, the amount of external force needed for closing the door 110 is effectively reduced.

The second input module 404 is configured to supply a current in a second direction to the electromagnet when the device 400 receives a second control signal transmitted from the distance sensor 150, so that the electromagnet repels the permanent magnet. The second control signal is generated by the distance sensor 150 when the distance sensor 150 detects the distance between the door 110 and the doorframe 120 is increasing. The second direction of the current is different from the first direction of the current.

The current in the second direction causes that a pole of the electromagnet to align towards a like pole of the permanent magnet, so that the electromagnet repels the permanent magnet. Because the electromagnet is arbitrarily located at one of the first region 112 of the door 110 and the second region 122 of the doorframe 120 and the permanent magnet is located at the other one of the first region 112 and the second region 122, the like poles create a repulsion force between the door 110 and the doorframe 120.

Consistent with the disclosed embodiments, the increasing of the distance between the door 110 and the doorframe 120 indicates that an external force (e.g., a force applied by the user of the microwave oven 10) is pulling the door 110 and causes the door 110 to move away from the doorframe 120. With the generation of the repulsion force between the door 110 and the doorframe 120, the amount of external force needed for opening the door 110 is effectively reduced.

FIG. 4B is a block diagram of the device 400 for controlling a door assembly, according to another exemplary embodiment. Referring to FIG. 4B, the device 400 further includes a first receiving module 406 and a transmitting module 408, in addition to the above-described first input module 402 and second input module 404.

The first receiving module 406 is configured to receive an activation signal transmitted from the door handle sensor 162. The activation signal is generated by the door handle sensor 162 when a parameter detected by the door handle sensor 162 reaches a predetermined parameter level.

Specifically, the door handle sensor 162 determines whether the detected parameter reaches the predetermined parameter level. When the parameter is determined to reach the predetermined parameter level, the door handle sensor 162 transmits the activation signal to the first receiving module 406. The present disclosure does not limit the specific manner for defining the predetermined parameter level.

The parameter detected by the door handle sensor 162 is indicative of one or more surface characteristics of the door handle 160. For example, the one or more surface characteristics may include but are not limited to: the surface temperature of the door handle 160, the brightness at the surface of the door handle 160, and/or the pressure applied on the surface of the door handle 160.

The transmitting module 408 is configured to transmit, to the distance sensor 150, an activation instruction for triggering the distance sensor 150 to detect a change of the distance between the door 110 and the doorframe 120.

Still referring to FIG. 4B, in some embodiments, the device 400 further includes a second receiving module 410, a querying module 412 and a third input module 414.

The second receiving module 410 is configured to receive, from the distance sensor 150, a third control signal indicative of an acceleration of the door 110. The third control signal is generated by the distance sensor 150 when the distance sensor 150 detects that the distance between the door 110 and the doorframe 120 is decreasing and the acceleration of the door 110 is greater than a predetermined threshold of acceleration. The present disclosure does not limit the value of the threshold.

The querying module 412 is configured to determine an amount of current corresponding to the acceleration of the door 110, by querying a predetermined relationship between the amount of the current and the acceleration of the door 110. The determined amount of current is positively correlated to the acceleration of the door 110. That is, the larger the acceleration of the door 110 is, the larger the determined amount of current is.

The third input module 414 is configured to supply the electromagnet with the determined amount of current in the second direction.

As known in the relevant art, the electromagnetic force caused by magnetic induction can be determined according to the following equation: F=B×I×L, where F is the electromagnetic force generated by a conductor, B is the intensity of a magnetic field surrounding the conductor, I is the amount of an electric current flowing through the conductor, and L is the length of the conductor. Accordingly, the electromagnetic force generated by the electromagnet is positively correlated to the amount of current flowing through the coil of the electromagnet. That is, by increasing the amount of the current flowing in the second direction, a larger repulsion force can be generated between the door 110 and the doorframe of 120.

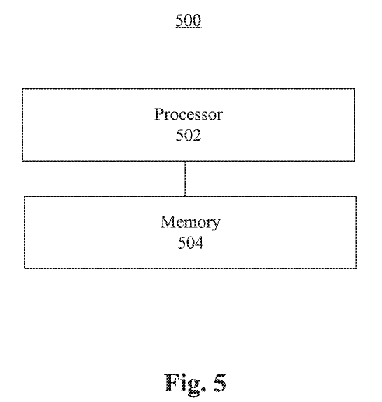

FIG. 5 is a block diagram of a device 500 for controlling a door assembly, according to an exemplary embodiment. For example, the device 500 may be implemented as a part or the whole of the control chip 140 in door assembly 100. Referring to FIG. 5, the device 500 includes a processor 502 and a memory 504 for storing instructions executable by the processor 502. The processor 502 is configured to perform the above described methods for controlling the door assembly 100.

In exemplary embodiments, there is also provided a non-transitory computer readable storage medium storing instructions, such as included in the memory 502, executed by the processor 504 in the device 500 to implement the above-described methods for controlling a door assembly.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A door assembly, comprising:
a door including a first region;
a doorframe connected to the door through a door hinge, the doorframe including a second region, wherein the first region faces the second region when the door is closed;
an electromagnet located at one of the first and second regions;
a permanent magnet located at the other one of the first and second regions;
a distance sensor configured to detect a distance between the door and the doorframe; and
a control chip coupled with the distance sensor, the control chip being configured to control a direction of a current in the electromagnet according to the distance detected by the distance sensor.

2. The door assembly according to claim 1, wherein:
the distance sensor is mounted at the first region, and
the distance detected by the distance sensor is a distance from the distance sensor to a plane on which the doorframe is located.

3. The door assembly according to claim 1, wherein:
the distance sensor is mounted at the second region, and
the distance detected by the distance sensor is a distance from the distance sensor to a plane on which the door is located.

4. The door assembly according to claim 1, further comprising:
a door handle attached to the door; and
a door handle sensor configured to detect a surface characteristic of the door handle, the surface characteristic including at least one of a surface temperature, a surface brightness, or a surface pressure of the door handle.

5. The door assembly according to claim 4, wherein the door handle sensor is coupled with at least one of the distance sensor or the control chip by a wired connection.

6. A method for controlling a door assembly, wherein the door assembly includes a door, a doorframe connected to the door through a door hinge, an electromagnet located at one of the door and the doorframe, a permanent magnet located at the other one of the door and the doorframe, a distance sensor configured to detect a distance between the door and the doorframe, and a control chip coupled with the distance sensor, the method comprising:
supplying, by the control chip, a current in a first direction to the electromagnet when the control chip receives a first control signal transmitted from the distance sensor, so that the electromagnet attracts the permanent magnet, the first control signal being generated by the distance sensor when the distance sensor detects the distance between the door and the doorframe is decreasing; and
supplying, by the control chip, a current in a second direction to the electromagnet when the control chip receives a second control signal transmitted from the distance sensor, so that the electromagnet repels the permanent magnet, the second control signal being generated by the distance sensor when the distance sensor detects the distance between the door and the doorframe is increasing,
wherein the first direction differs from the second direction.

7. The method according to claim 6, wherein:
the door assembly further includes a door handle attached to the door, and a door handle sensor configured to measure a parameter indicative of a surface characteristic of the door handle; and
the method further includes:
receiving, by the control chip, an activation signal transmitted from the door handle sensor, the activation signal being generated by the door handle sensor when the measured parameter reaches a predetermined parameter level; and
transmitting, by the control chip to the distance sensor in response to receiving the activation signal, an activation instruction for triggering the distance sensor to detect a change of the distance between the door and the doorframe.

8. The method according to claim 6, further comprising:
receiving, by the control chip from the distance sensor, a third control signal indicative of an acceleration of the door, the third control signal being generated by the distance sensor when the distance sensor detects the distance between the door and the doorframe is decreasing and the acceleration of the door is greater than a predetermined threshold;
determining, by the control chip, an amount of current corresponding to the acceleration of the door, the determined amount of current being positively correlated to the acceleration of the door; and
supplying, by the control chip, the determined amount of current in the second direction to the electromagnet.

9. The method according to claim 7, further comprising:
receiving, by the control chip from the distance sensor, a third control signal indicative of an acceleration of the door, the third control signal being generated by the distance sensor when the distance sensor detects the distance between the door and the doorframe is decreasing and the acceleration of the door is greater than a predetermined threshold;
determining, by the control chip, an amount of current corresponding to the acceleration of the door, the determined amount of current being positively correlated to the acceleration of the door; and
supplying, by the control chip, the determined amount of current in the second direction to the electromagnet.

10. A device for controlling a door assembly, wherein the door assembly includes a door, a doorframe connected to the door through a door hinge, an electromagnet located at one of the door and the doorframe, a permanent magnet located at the other one of the door and the doorframe, and a distance sensor configured to detect a distance between the door and the doorframe, the device comprising:
a processor; and
a memory configured to store instructions executable by the processor;
wherein the processor is configured to:
when receiving a first control signal transmitted from the distance sensor, supply the electromagnet with a current in a first direction, so that the electromagnet attracts the permanent magnet, the first control signal being generated by the distance sensor when the distance sensor detects the distance between the door and the doorframe is decreasing; and
when receiving a second control signal transmitted from the distance sensor, supply the electromagnet with a current in a second direction, so that the electromagnet repels the permanent magnet, the second control signal being generated by the distance sensor when the distance sensor detects the distance between the door and the doorframe is increasing,
wherein the first direction differs from the second direction.

11. The device according to claim 10, wherein:
the door assembly further includes a door handle attached to the door, and a door handle sensor configured to measure a parameter indicative of a surface characteristic of the door handle; and
the processor is further configured to:
receive an activation signal transmitted from the door handle sensor, the activation signal being generated by the door handle sensor when the measured parameter reaches a predetermined parameter level; and
transmit, to the distance sensor in response to receiving the activation signal, an activation instruction for triggering the distance sensor to detect a change of the distance between the door and the doorframe.

12. The device according to claim 10, herein the processor is further configured to:
receive from the distance sensor a third control signal indicative of an acceleration of the door, the third control signal being generated by the distance sensor when the distance sensor detects the distance between the door and the doorframe is decreasing and the acceleration of the door is greater than a predetermined threshold;
determine an amount of current corresponding to the acceleration of the door, the determined amount of current being positively correlated to the acceleration of the door; and
supply the electromagnet with the determined amount of current in the second direction.

13. The device according to claim 11, wherein the processor is further configured to:
receive from the distance sensor a third control signal indicative of an acceleration of the door, the third control signal being generated by the distance sensor when the distance sensor detects the distance between the door and the doorframe is decreasing and the acceleration of the door is greater than a predetermined threshold;
determine an amount of current corresponding to the acceleration of the door, the determined amount of current being positively correlated to the acceleration of the door; and
supply the electromagnet with the determined amount of current in the second direction.
